(19) United States
(12) Patent Application Publication
(10) Pub. No.: US 2007/0024718 A1
(43) Pub. Date: Feb. 1, 2007

(54) IMAGE CAPTURING DEVICE AND IMAGE ADJUSTING METHOD THEREOF

(75) Inventors: Chih-Shih Yu, Hsinchu City (TW); Hung-Sheng Cheng, Taichung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ALPHA IMAGING TECHNOLOGY CORP., Hsinchu County (TW)

(21) Appl. No.: 11/459,976

(22) Filed: Jul. 26, 2006

(30) Foreign Application Priority Data
Jul. 28, 2005 (TW) 94125659

(51) Int. Cl. H04N 5/228

(52) U.S. Cl. 348/222.1

(57) ABSTRACT

An image capturing device includes an image sensor and an image processor is provided. The image sensor is used for sensing and converting a light source into an image. The image is composed of a number of pixels. Each pixel corresponds to a color data, respectively. The image processor adjusts the corresponding color data of a pixel according to the position of the corresponding pixel in the image and then outputs an adjusted image.

This application claims the benefit of Taiwan application Serial No. 94125659, filed Jul. 28, 2005, the subject matter of which is incorporated herein by reference.

### BACKGROUND OF THE INVENTION

1. Field of the Invention

The invention relates in general to an image capturing device, and more particularly to an image capturing device and an image adjusting method thereof applied in a mobile communication device.

2. Description of the Related Art

As the size of mobile phone is now getting smaller and smaller, the lens of the built-in digital camera of mobile phone is also getting smaller and smaller. According to the imaging characteristics of the lens, when the lens becomes smaller, the focal length of imaging is shortened and the imaging angle is enlarged, causing color space non-uniformity to the obtained image. Besides, the color space non-uniformity would arise if the micro lens disposed on the surface of the image sensor of the digital camera is poor designed. For example, when a piece of plain paper is shot, the color in the center of the obtained image would not be the same with the color in the peripheral of the obtained image.

Because of the color space non-uniformity, the quality of the image obtained using the digital camera of mobile phone is deteriorated. Consequently, how to improve the image quality in response to the miniaturization of the lens has thus become an imminent challenge to be resolved.

### SUMMARY OF THE INVENTION

It is therefore an object of the invention to provide an image capturing device and an image adjusting method thereof to resolve the problem of image deterioration caused by color space non-uniformity.

The invention achieves the above-identified object by providing an image capturing device including an image sensor and an image processor. The image sensor is used for sensing and converting a light source into an image. The image is composed of a number of pixels. Each pixel corresponds to a color data respectively. The image processor adjusts the color data corresponding to each pixel according to the position of each pixel in the image, and then outputs an adjusted image accordingly.

The invention further achieves the above-identified object by providing an image adjusting method. The method includes the following steps. An image composed of a number of pixels is received. Each pixel respectively corresponds to a color data. The color data corresponding to each pixel is adjusted as an adjusted color data according to the position of each pixel in the image. An image frame is displayed according to the adjusted color data.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a mobile communication device according to a preferred embodiment of the invention;

FIG. 2 is a flowchart of an image adjusting method;

FIG. 3 is a diagram showing an example of the image adjusting method;

FIG. 4 is a diagram showing the other example of the image adjusting method; and

FIG. 5 is a block diagram of the other example of the mobile communication device.

### DETAILED DESCRIPTION OF THE INVENTION

The invention provides an image capturing device and an image adjusting method thereof for adjusting the corresponding color data of a pixel according to the position of the corresponding pixel in the image to compensate the image distortion caused by color space non-uniformity, thereby improving the quality of the image outputted by the image capturing device. Examples of the image capturing device include mobile information processing devices, such as digital camera, digital video recorder, PC Cam or mobile communication device. Examples of the mobile communication device include GSM mobile phone or PHS mobile phone. The present embodiment of the invention does not restrict the type of the mobile information processing device nor the type of the mobile communication device.

Referring to FIG. 1, a block diagram of a mobile communication device according to a preferred embodiment of the invention is shown, Examples of the mobile communication device 100 include ordinary GSM mobile phone. The GSM mobile phone includes an image capturing device 102 and a display unit 108. The image capturing device 102 includes an image sensor 104 and an image processor 106. Examples of the image sensor 104 used for sensing and converting a light source an image I includes charge-coupled device (CCD). The CCD is used for converting the obtained image into the image I composed of several pixels. The image processor 106 receives the image I and outputs an adjusted image AI′ according to the received image I. The display unit 106 displays an image frame according to the adjusted image AI′.

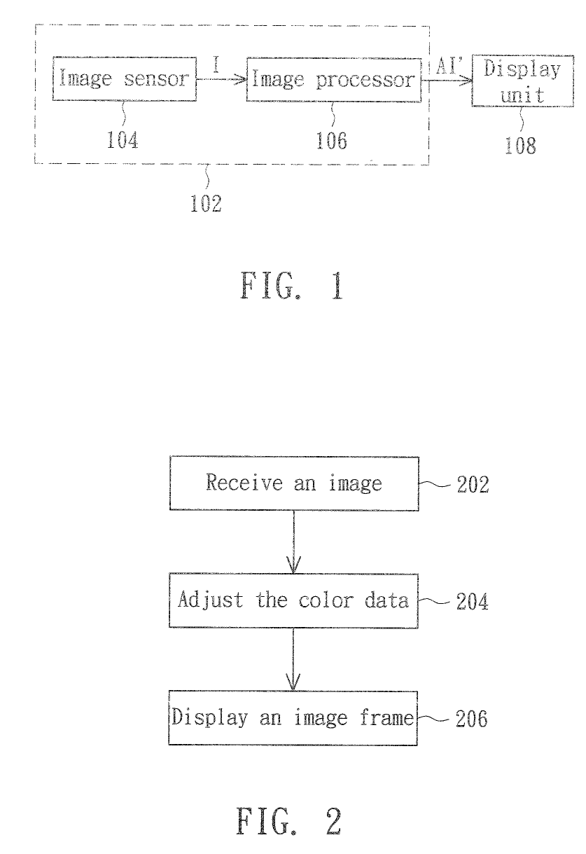

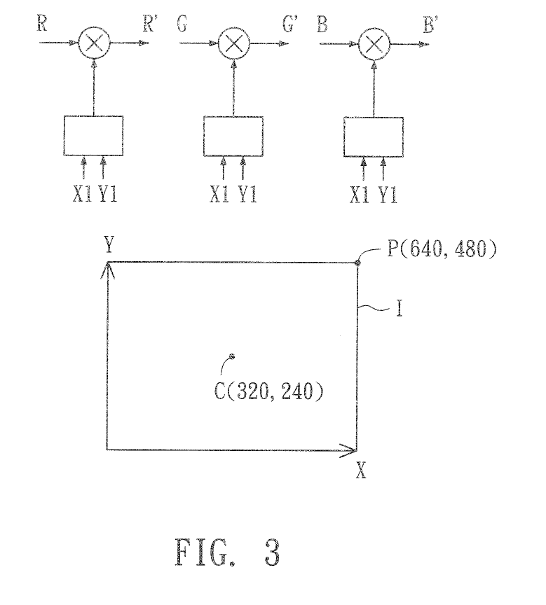

Referring to FIG. 2, a flowchart of an image adjusting method is shown. The image adjusting method is applied in the above mentioned mobile communication device 100. Firstly, the method begins at step 202, an image I is received. Next, proceed to step 204, the color data corresponding to each pixel is adjusted according to the coordinate position of each pixel in the image I to output an adjusted color data. Afterwards, proceed to step 206, an image frame is displayed according to the adjusted color data.

Moreover, the mobile communication device 100 further includes an optical module (not shown in FIG. 1). Examples of the optical module include imaging elements such as lens, diaphragm and shutter. The image sensor 104 receives and converts a light source provided by the optical module into an image I, and then outputs the image I to the image processor 106.

The image I is composed of a number of pixels, each denoted by a corresponding color data. Each color data includes three color brightness data, namely, the first color brightness data, the second color brightness data and the third color brightness data. For example, the first color brightness data is a red brightness data R, the second color brightness data is a green brightness data G, and the third color brightness data is a blue brightness data B (the red brightness data R, the green brightness data G and the blue brightness data B arm denoted by RGB brightness data hereinafter). Or, the three color brightness data are respectively denoted by the YUV brightness saturation data. The image adjusting method according to the present embodiment of the invention does not restrict the type of the color data. Any color data capable of correspondingly denoting the image I will do.

Referring to FIG. 3, a diagram showing an example of the image adjusting method is shown. The corresponding coordinate position of a pixel as shown in FIG. 3 is denoted by two-dimensional coordinates (X, Y) in the image I. Examples of the color data include RGB brightness data. Through experiments, the image adjusting method can locate the coordinate position of a pixel in the image I, the respective span of adjustment required for adjusting the RGB brightness data, and create a reference weighting table according to the respective span of adjustment. The reference weighting table, which includes weighting values of each coordinate position, is stored in the memory. For example, when a piece of plain white paper is shot, the respective span of adjustment of the RGB brightness data of each pixel in the image is recorded. The color space non-uniformity is resolved according to the span of adjustment,

Thus, the image processor 106 can refer the corresponding position of the XY coordinates of a pixel to the reference weighting table to obtain the respective span of adjustment of the RGB brightness data. For example, in the image I composed of 640×480 pixels, the coordinate position of a central pixel C is (X1=320, Y1=240), and the corresponding RGB brightness data of the central pixel C are (R=100, G=100, B=100). The coordinate position of a corner pixel P is expressed as (X1=640; Y1=480), and the corresponding RGB brightness data of the corner pixel P is expressed as (R=50, G=60, B=40). The color of the central pixel C is not the same with the color of the corner pixel P. If the pixel P is less blue than the central pixel C, the image processor 106 would multiply the color data (50, 60, 40) of the pixel P by (1.2, 1, 1.5) respectively to become an adjusted color data (R′=60, G′=60, B′=60), so that both the pixel C and the pixel P would become colorless and that the problem of color space non-uniformity is resolved. Lastly, the image processor 106 outputs an adjusted image AI′ according to the adjusted color data.

Then, the display unit 108 displays an image frame according to the adjusted image AI′. By doing so, both the color space non-uniformity caused by the imaging characteristics of the optical module and the color space non-uniformity caused by the photosensing element of the image sensor 104 such as a micro lens for instance can be compensated by adjusting the corresponding color data of a pixel according to the corresponding coordinate position of the pixel in the image I, thereby improving the image quality of the frame displayed by the display unit 108.

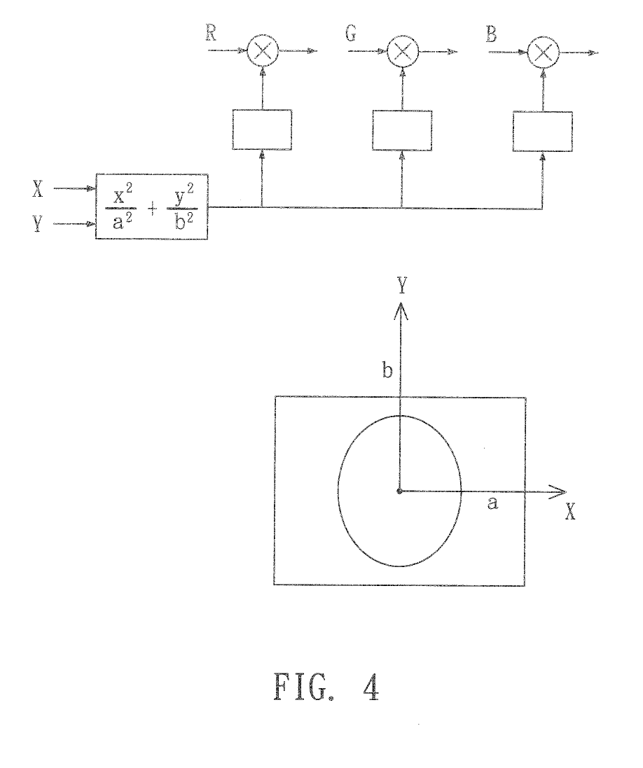

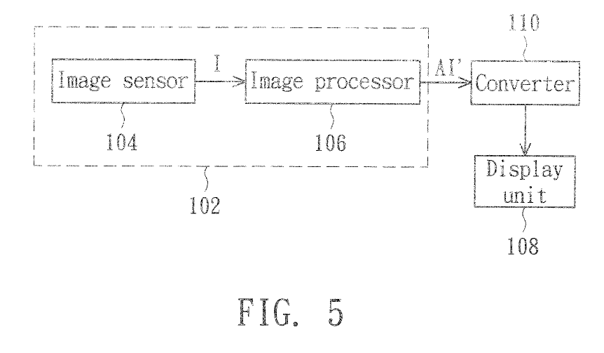

Referring to FIG. 4, a diagram showing the other example of the image adjusting method is shown. The color space non-uniformity which is symmetric to the central point of the image is compensated according to a circular or an elliptical model. That is, for the pixels having equal distance from the central point of the image, the same span of adjustment is applied to adjust their respective RGB brightness data. Similarly, through experiments, the image adjusting method can obtain the respective span of adjustment required for adjusting the RGB brightness data with regard to the distance between a pixel and the central point of the image, and create a reference weighting table according to the respective span of adjustment. Then, the image processor 106 adjusts the color data of a pixel as an adjusted image according to the reference weighting table, and outputs the adjusted image accordingly. Besides, according to the imaging characteristics of the lens, several formulae of ellipse are established using the central point of the image is used as a circular center, and the same amount of compensation is applied to the pixels within the same formula of ellipse. Therefore, the image adjusting method of the invention does not restrict the type of the position of each frame in the image I as long as the corresponding color data of a pixel can be adjusted according to the position of the corresponding pixel in the image and that the color space non-uniformity occurring to the image AI′ outputted by the image capturing device 102 can be resolved.

Besides, the mobile communication device 100 further includes a converter 110. Referring to FIG. 5, a block diagram of the other example of the mobile communication device is shown. The converter 110 bridged between the image processor 106 and the display unit 108 is used for converting the data type of the adjusted image AI′ and enabling the display unit 108 to display an image frame according to the adjusted image AI′. For example, the adjusted image AI′ outputted by the image processor 106 is denoted by YUV brightness saturation data. However the display unit 108 can only use the converter 110 to convert the data type of the adjusted image AI′ into an RGB brightness data when the display unit 108 only displays image according to the RGB brightness data.

According to the image capturing device and an image adjusting method thereof disclosed in the above embodiment of the invention, the problems of image distortion caused by color space non-uniformity can be resolved by adjusting the corresponding color data of a pixel according to the position of the corresponding pixel in the image, thereby improving image quality and enhancing the visual performance of the image.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image capturing device, comprising:
an image sensor for sensing and converting a light source into an image, wherein the image includes a plurality of pixels and each pixel includes a color data respectively; and
an image processor for adjusting each of the color data according to the position of each pixel in the image and outputting an adjusted image.

2. The image capturing device according to claim 1 being applied in a mobile information processing device.

3. The image capturing device according to claim 2, wherein the mobile information processing device is a mobile communication device.

4. The image capturing device according to claim 2, wherein the mobile information processing device has a display unit for displaying an image frame according to the adjusted image.

5. The image capturing device according to claim 4, further comprising a converter for receiving the adjusted image, converting an image data type of the adjusted image, and outputting the converted image data type to the display unit.

6. The image capturing device according to claim 1, wherein the image sensor is a charge-coupled device (CCD).

7. The image capturing device according to claim 1, wherein the image processor adjusts each of the color data to an adjusted color data respectively according to the distance between the coordinate position of each pixel in the image and the central point of the image.

8. The image capturing device according to claim 7, further comprising:
a reference weighting table for storing weighting values of the pixels,
wherein the image processor adjusts each of the color data to the adjusted color data respectively according to each of the color data and each of the weighting value.

9. The image capturing device according to claim 8, each of the color data comprising a first color data, a second data, and a third data.

10. The image capturing device according to claim 9, each of the weighting value comprising a first weighting value corresponding to the first color data, a second weighting value corresponding to the second color data, and a third weighting value corresponding to the third color data.

11. An image adjusting method, comprising
(a) receiving an image which includes a plurality of pixels, wherein each pixel includes a color data respectively;
(b) adjusting the color data of each pixel as an adjusted color data according to the position of each pixel in the image; and
(c) displaying an image frame according to the adjusted color data.

12. The image adjusting method according to claim 11, wherein each color data comprises a first color data a second data, and a third data.

13. The image adjusting method according to claim 12, wherein the first color data is a red brightness data, the second data is a green brightness data and the third data is a blue brightness data.

14. The image adjusting method according to claim 12, applied in a mobile communication device which comprises:
an image sensor for sensing and converting a light source into the image;
an image processor for adjusting each of the color data as the adjusted color data; and
a display unit for displaying the image frame according to the adjusted color data.
